(19) United States
(12) Patent Application Publication
(10) Pub. No.: US 2025/0255312 A1
(43) Pub. Date: Aug. 14, 2025

(54) METHODS AND SYSTEMS FOR PRODUCTION OF HIGH FIBER BAKED GOODS

(71) Applicant: Intercontinental Great Brands LLC, East Hanover, NJ (US)

(72) Inventors: Indraneil Mukherjee, East Hanover, NJ (US); Clive Norton, East Hanover, NJ (US)

(21) Appl. No.: 18/704,874

(22) PCT Filed: Oct. 31, 2022
(86) PCT No.: PCT/US2022/048424

§ 371 Date: Apr. 25, 2024

Related U.S. Application Data
(60) Provisional application No. 63/275,874, filed on Nov. 4, 2021.

(30) Foreign Application Priority Data
Aug. 12, 2022 (GB) 2211830.1

(51) Int. Cl. A21D 2/18; A21D 2/36; A21D 13/062; A23L 29/30; A23L 33/125; A23L 33/22; A23L 33/24; A23L 33/26

(52) U.S. Cl. CPC A21D 2/186; A21D 2/181; A21D 2/188; A21D 2/362; A21D 2/364; A21D 13/062; A23L 29/30; A23L 33/125; A23L 33/22; A23L 33/24; A23L 33/26

(57) ABSTRACT

Low calorie and low fat baked goods and methods of making thereof are provided. The baked goods include insoluble dietary fiber and low calorie bulking agents and have low moisture, low water activity, and low fat and calorie levels, providing consumers with a desirable taste and organoleptic properties while also satisfying today's health-conscious consumers.

### FIELD

The present application generally relates to baked goods, and more particularly to low calorie baked goods containing insoluble dietary fibers and low calorie bulking agents.

### BACKGROUND

Generally, consumption of excessive calories has been associated with unhealthy conditions such as heart disease and obesity. Additionally, excessive intake of saturated fat has been particularly associated with increased ‘bad cholesterol’ and higher risk of heart disease, stroke, etc., which has led to an emphasis on decreasing the levels of saturated fats in prepared/processed foods.

Generally, the World Health Organization (WHO) has recommended keeping consumption of simple sugars to no more than 10% of a 2000 kcal daily diet, which amounts to about 50 g/day. While researchers continue to debate a direct link between excessive intake of digestible sugars and type II diabetes and/or obesity, regulatory bodies (and increasingly consumers) have developed a negative perception of this ingredient, leading to an effort across the food industry to decrease sugar content of food products. In addition, governments across the world have started using various strategies to discourage consumers from purchasing food products that exceed recommended thresholds for energy and/or certain nutrients such as sugar. This especially affects sweet baked goods and confections, where sugar not only provides sweetness but also acts as a ‘bulking agent’ contributing to the unique texture of food products.

Notably, the definition of ‘sugar’ as reported in the ‘total sugars’ or ‘sugars’ row in the ‘nutrition facts table’ of a food product can vary based on local regulations. As used herein, the term “sugar” refers to a monosaccharide or disaccharide with a nutrient energy content of greater than 3 kcal/g. Examples of suitable sugars include glucose, fructose, galactose, sucrose, lactose, maltose, and sugar hydrates (such as dextrose monohydrate, for example), among others. This is because the rationale behind the WHO recommendation is to limit the intake of ‘free’ sugars which contribute to overall energy of diets. Such ‘free’ sugars may also be described as ‘caloric’ or ‘readily metabolizable’ sugars.

Due to pressure from both regulatory bodies and consumers, food manufacturers continuously attempt to lower the fat and calorie content of their products. Fats are typically the highest caloric contributors in foods (i.e., foods rich in fat typically have high energy or calorie values). As used herein, the term “fat” refers to fully caloric fat, i.e., 9 kcal/g.

While low calorie fats do exist (e.g., Salatrim™, Olestra™, etc.), they also are known to have highly undesirable digestive effects. Some food manufacturers attempt to reduce the calorie content of foods by using sugars that are only non-digestible (or partially or non-digestible) mono and disaccharides, for example, xylose, arabinose, allulose, allose, altrose, tagatose, sorbose, mannose, cellobiose, xylobiose, leucrose, lactulose, nigerose, kojibiose, etc., some of which are referred to as ‘rare sugars’, ‘non-caloric sugars’ or ‘low calorie sugars.’ These sugars have <3 kcal/g nutrient energy.

Notably, some manufacturers also try to replace sugars with sugar replacers such as sugar-free/calorie-free sweeteners (some of which may be artificial sweeteners such aspartame, sucralose, etc., and some of which may be sugar alcohols (polyols) such as sorbitol, erythritol, etc.). Generally, the term “sugar replacer” refers to bulking agents, high potency sweeteners, and protein-based sugar replacers. For example, bulking agents include but are not limited to materials having an energy content of ≤3 kcal/g, for example, monosaccharides, disaccharides, oligosaccharides, polysaccharides, sugar alcohols (including hydrogenation products of any monosaccharides, disaccharides, and oligosaccharides/polysaccharides containing 3 or more monosaccharide units), and soluble dietary fibers.

In addition, non-digestible and/or digestion-resistant carbohydrates such as sugar alcohols (e.g., maltitol, erythritol, sorbitol, xylitol, etc.), rare sugars (e.g., allulose, sorbose, tagatose, allose, altrose, gulose, idose, talose) and soluble fibers (e.g., digestion-resistant dextrins from sources like corn (soluble corn fiber), wheat, tapioca, etc., oligosaccharides like fructo-oligosaccharides, xylo-oligosaccharides, galacto-oligosaccharides, soy-bean oligosaccharides, human milk oligosaccharides, etc., higher molecular weight soluble fibers like gum acacia, inulin, arabinoxylans, β-glucans, etc.) may be used as bulking agents to replace sugar in baked goods. However, their usage is typically restricted by local regulations due to various issues. For example, sugar alcohols may need to be declared as a separate row in the product nutrition facts column and require a laxation warning at high usage levels. On the other hand, soluble fibers may have digestive tolerance concerns at high usage levels. Rare sugars, being novel foods may have restricted category allowance limits even in regions where they are approved.

In recent years, consumers have developed a negative perception of such sweeteners, which has led regulators to require food manufacturers to list the sugar alcohol content of products on a separate row in the ‘nutrition facts table.’ In addition, consumer perception over time has shifted to an aversion toward ‘non-natural’ ingredients, which has made the use of artificial sweeteners commercially less attractive. Unlike the ingredients described above, recent research has contributed to developing an increasingly positive perception of dietary fiber in the minds of consumers. While always considered an important dietary component for its contribution to bowel regularity, the importance of dietary fiber in maintaining healthy gut microflora leading to several desirable health outcomes has been recently discovered.

Notably, the term dietary fiber generally refers to the indigestible portion of food derived from plants and has two components, namely, soluble dietary fiber and insoluble dietary fiber. Soluble dietary fiber dissolves in water and may be readily fermented in the colon into gases and physiologically active byproducts. On the other hand, insoluble dietary fiber does not dissolve in water and is known to provide a bulking effect by absorbing water as the insoluble dietary fiber moves through the digestive system. From a caloric contribution perspective, per most local regulations, insoluble fibers do not contribute any calories (i.e., zero calories) to the food product, while soluble fibers (per most local regulations) contribute 2 kcal/g to the food product. Notably, per applicable European Union regulations, all fibers, soluble and insoluble, are considered to contribute 2 kcal/g to the food product.

Insoluble dietary fibers are considered to be particularly beneficial relative to other types of carbohydrates because they provide even fewer calories relative to soluble fibers (the insoluble dietary fiber portion of the total dietary fiber is 0 kcal/g, while the soluble dietary fiber counts as 2 kcal/g). In addition, insoluble dietary fibers are known to be better tolerated digestively, likely due to lower rate of gas generation from microbial fermentation in the colon. Further, since insoluble dietary fibers are not sugar alcohols, they do not require laxation warnings at high use levels.

Due to low intake of dietary fiber in a typical modern diet, some government regulations may incentivize food manufacturers to increase the dietary fiber content of food products. However, maximizing the dietary fiber content, while at the same time maintaining calorie, fat, and sugar content under certain threshold values in baked goods containing artificial sweeteners and bulking agents continues to remain a challenge from a manufacturing standpoint.

### SUMMARY

In view of the foregoing background, an aim of the present inventors was to maximize the dietary fiber content of baked good products at the expense of the other (less desirable) components, especially fats and caloric sugars. However, as mentioned above, maximizing the insoluble dietary fiber content while simultaneously minimizing fat, sugar and calorie content of the baked good continues to remain a technical challenge, at least due to the fact that insoluble fibers absorb a significant amount of moisture and hence compete with flour for formula water, resulting in a softer texture, higher moisture content and higher water activity, which are all undesirable properties for a dough that is made for the purpose of baking it in an oven.

For example, the presence of high moisture content in a baked biscuit undesirably impacts texture, typically leading to undesirably soft texture in biscuits. Furthermore, high moisture levels in many cases is also associated with high water activity, which can lead to undesirable microbial growth. The present inventors discovered compositions and methods for creating baked goods that contain significant amounts of dietary fiber (e.g., 12 to 53%) while using no more than 10% sugars and simultaneously keeping the moisture content below 15% and the total product calories in the 180-320 kcal per 100 gram (g) range.

In some embodiments, a baked good comprises from about 7 wt. % to about 41 wt. % insoluble dietary fiber; from about 5 wt. % fat to about 16 wt. % fat; a ratio of the insoluble dietary fiber to the fat of from about 0.5 to about 4.5; from about 10 wt. % to about 35 wt. % low calorie bulking agent; sugar in an amount of up to 10 wt. %; moisture in an amount of up to 15 wt. %; a water activity of up to 0.7; and a total caloric content of about 180-320 kcal per 100 g of the baked good. The baked good may be a biscuit or a cookie or the like.

The insoluble dietary fiber may be from a source including but not limited to at least one of: brans, celluloses, hemicelluloses, lignins, resistant starches, flours, insoluble chicory root fiber, isolated plant fibers, cocoa powder, pecan shell fiber, maple fiber, cocoa pod husk fiber, agave pina fiber, and the like. The sugar may include but is not limited to glucose, fructose, galactose, sucrose, lactose, maltose, isomaltose, isomaltulose (palatinose), trehalulose, trehalose, sugar hydrates, and the like.

The low calorie bulking agents may include but are not limited to: xylose, arabinose, allulose, sorbose, tagatose, allose, altrose, mannose, cellobiose, tagatose, sorbose, nigerose, kojibiose, inulobiose, and xylobiose. In some embodiments, the low calorie bulking agent is a sugar alcohol which may be, for example, maltitol, isomalt, erythritol, lactitol, mannitol, sorbitol, and xylitol. In other embodiments, the low calorie bulking agent does not include a sugar alcohol.

The fat may include but is not limited to: canola oil, palm oil, high oleic canola oil, soybean, safflower, sunflower, palm kernel oil, shea butter, mango kernel oil, illipe oil, sal oil, olive oil, ground nut (peanut) oil, almond oil, avocado oil, coffee oil, milk fat, cocoa butter or fractions or equivalents of cocoa butter, polyglycerol esters, glycerophospholipids, mono- and di-glycerides, sucrose monoesters, sorbitan esters, polyethoxylated glycols, agar, albumin, casein, glyceryl monostearate, gums, soaps, irish moss, egg yolk, lecithin, and mixtures thereof. In some embodiments, fats from finely milled nuts and seeds may be used in the form of nut and seed butters or paste, e.g., hazelnut paste, peanut butter, cashew butter, almond butter, sunflower seed butter, sesame seed paste (tahini), pumpkin seed butter, etc. In some embodiments the fat is an oil produced using biotechnological approaches.

In certain aspects, the baked goods include not only insoluble dietary fiber, but also soluble dietary fiber and include from about 12 wt. % to about 53 wt. % total dietary fiber. In some implementations, the ratio of the total dietary fiber to the fat is from about 1.0 to about 5.5. The soluble dietary fiber may be selected from a source including but not limited to: polydextrose, inulin, fructo-oligosaccharides, kestose, nystose, raffinose, galacto-oligosaccharides, gentiotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, human milk oligosaccharides, 2′-fucosyl lactose, lacto-n-neotetraose, glucan (i.e., glucose containing) oligosaccharides, isomalto-oligosaccharides, (soluble fiber fraction), cello-oligosaccharides (or cellodextrins), resistant dextrins (e.g., soluble corn fiber, soluble wheat fiber, soluble tapioca fiber), nigero-oligosaccharides, nigerotriose, nigerotetraose, kojitriose, kojitetraose, dextrans, beta glucans, lichenan, and isolichenan.

In some embodiments, the baked good comprises from about 7 wt. % to about 41 wt. % insoluble dietary fiber; soluble dietary fiber; from about 12 wt. % to about 53 wt. % total dietary fiber; from about 5 wt. % fat to about 16 wt. % fat; a ratio of the insoluble dietary fiber to the fat of from about 0.5 to about 4.5; from about 10 wt. % to about 35 wt. % low calorie bulking agent; sugar in an amount of up to 10 wt. %; moisture in an amount of up to 15 wt. %; a water activity of up to 0.7; and a total caloric content of about 180-320 kcal per 100 g of the baked good.

In certain embodiments, the baked goods include saturated fats in an amount from about 8.5 wt. % to about 60 wt. % of the total fat content of the baked goods. The saturated fat may account for about 2.9% to about 13.8% of the total caloric content of the baked good.

In some implementations, the from about 0.5% to about 8.5% of the total caloric content of the baked good comes from sugar and from about 20% to about 44% of the total caloric content of the baked good comes from fat.

Without wishing to be limited by theory, the present inventors have discovered and demonstrated that fat and sugar can be replaced to a significantly large extent in baked goods (biscuits, cookies, etc.) by way of using dietary fiber, more specifically, insoluble dietary fiber, and low calorie bulking agents. The present inventors also discovered that in addition to being able to replace a large percentage of sugar in baked goods, insoluble dietary fibers and low calorie bulking agents can be advantageously used to replace a portion of the fat as well, resulting in baked goods having very low fat (e.g., as low as 5 wt. %).

As shown in the Examples section below, the present inventors were able to successfully prepare calorie-reduced and sugar-reduced baked biscuits as exemplary inventive baked goods. Of course, while the Examples are directed to baked biscuits, it will be appreciated that the baked goods may include any baked goods (e.g., cookies, wafers, biscotti, short breads, muffins, barks, etc.).

### DETAILED DESCRIPTION

This application describes baked goods advantageously having reduced fat and calorie content while having high insoluble dietary fiber content and low calorie content and exhibiting pleasant organoleptic properties when consumed, as well as to methods of preparing and baking thereof. Generally, low calorie and low fat baked goods described herein (e.g., biscuits, cookies, or the like) include: from about 7 wt. % to about 41 wt. % insoluble dietary fiber and from about 5 wt. % fat to about 16 wt. % fat, with the ratio of the insoluble dietary fiber to the fat being from about 0.5 to about 4.5; from about 10 wt. % to about 35 wt. % low calorie bulking agent; and up to 10 wt. % sugar.

Generally speaking, the baked goods described herein have low moisture, low water activity and low caloric content, for example, up to 15 wt. % moisture; a water activity (A_{w}) of up to 0.7. As mentioned above, the presence of high moisture content in a baked biscuit undesirably impacts texture, typically leading to undesirably soft texture in biscuits, and high moisture/high water activity can lead to undesirable microbial growth. In addition, given that many of today's health-conscious consumers prefer low-calorie products while at the same time avoiding ingredients that may be perceived as not natural, the baked goods described herein contain significant amounts of dietary fiber and insoluble dietary fiber and while simultaneously having low sugar and fat content and a total calories in the 180-320 kcal per 100 gram (g) range, which is considered to be low by many standards.

As mentioned above, replacing fat and sugar in baked goods with bulking agents rich in insoluble dietary fiber is particularly advantageous and leads to significant calorie and sugar reduction. Examples of commercially available insoluble dietary fiber-rich bulking agents that may be used in the embodiments of the baked goods described herein include, but are not limited to insoluble fibers sourced from including at least one of: brans (e.g., oat, corn, barley, wheat, rice, etc.), cellulose of various food grades (e.g., microcrystalline cellulose, supercritical crystalline cellulose, amorphous cellulose, etc.), insoluble chicory root fiber, isolated plant fibers (pea fiber, wheat fiber, oat fiber, potato fiber, vanilla fiber, sugarcane fiber, insoluble chicory root fiber, citrus fiber, etc.), resistant starches (e.g., high amylose—RS2, chemically modified—RS4), cocoa powder (e.g., defatted cocoa powder), ground up plant waste, such as stalks, stones, pits, and husks (e.g., wheat straw, corn stover, sugar cane bagasse, pecan shell fiber, cocoa shell fiber, cocoa pod husk fiber, agave pina fiber, pistachio shell powder, etc.), and the like. As mentioned above, the baked goods according to various embodiments described herein may include from about 7 wt. % to about 41 wt. % insoluble dietary fiber, which represents a significant and advantageous increase in the insoluble dietary fiber content of the baked goods at the expense of sugar and fat, resulting in baked goods having low fat, sugar, and calorie content, which are desirable for consumers.

The baked goods according to various embodiments described herein include from about 5 wt. % to about 16 wt. % fat, which may account for about 20% to about 44% of their total caloric content. In some of the embodiments, saturated fat represents from about 8.5 wt. % to about 60 wt. % of the total fat content and accounts for about 2.9% to about 13.8% of the total caloric content of the baked goods. Exemplary fat components that may be used in the baked goods according to the embodiment described herein include but are not limited to: canola oil, palm oil, high oleic canola oil, soybean, safflower, sunflower, palm kernel oil, shea butter, mango kernel oil, illipe oil, sal oil, olive oil, milk fat, cocoa butter or fractions or equivalents of cocoa butter, polyglycerol esters, glycerophospholipids, mono-and di-glycerides, sucrose monoesters, sorbitan esters, polyethoxylated glycols, agar, albumin, casein, glyceryl monostearate, gums, soaps, Irish moss, egg yolk, lecithin, and mixtures thereof. In some aspects, fats from finely milled nuts and seeds may be used in the form of nut and seed butters or paste, e.g., hazelnut paste, peanut butter, cashew butter, almond butter, sunflower seed butter, sesame seed paste (tahini), pumpkin seed butter, etc. In some aspects, the fat is an oil produced using biotechnological approaches.

As shown in the Examples below, the baked goods according to the embodiments described herein have a ratio of the insoluble dietary fiber to fat of from about 0.5 to about 4.5. Notably, some of the dough formulations discussed in the Examples section that had a ratio of the insoluble dietary fiber to fat that exceeded 4.5 (even by 0.1, see Example 4) failed to make a biscuit, pointing to the criticality of the insoluble dietary fiber to fat ratio in the baked goods.

As mentioned above, the baked goods according to various embodiments described herein include from about 10 wt. % to about 35 wt. % low calorie sweetener (also referred to herein as a bulking agent). In some embodiments, the low calorie sweetener/bulking agent used in the baked goods may be a sugar alcohol, for example, maltitol, erythritol, sorbitol, xylitol, or the like. Due to consumer sensitivity around sugar alcohols and requirement for separate warnings on labels, some of the embodiments of the baked goods described herein do not include sugar alcohol sweeteners/bulking agents.

In some implementations, the baked goods may include, in an amount of up to 10 wt. %, sugars, which may include, but are not limited to: glucose, fructose, galactose, sucrose, lactose, maltose, isomaltose, isomaltulose, trehalose, trehalulose and sugar hydrates. Notably, the sugars present in the exemplary baked goods described herein may account for about 0.5% to about 8.5% of the total caloric content of the baked goods.

In some implementations, the low calorie sweetener/bulking agent of the baked goods described herein is a non-sugar alcohol. Exemplary non-sugar alcohols that may be used include, but are not limited to allulose, arabinose, xylose, sorbose, tagatose, ribose, rhamnose, allose, mannose, cellobiose, kojibiose, nigerose, xylobiose, mannobiose, inulobiose, leucrose, turanose, maltulose, trehalulose, stevia, monkfruit, monkfruit juice solids, sucralose, aspartame, Ace-K, neotame, and saccharin. steviol glycoside, rebaudiosides (e.g. A, B, C, D, E, F, M, N, O), dulcoside A, rubusoside, steviolbioside, mogroside IV, mogroside V, Luo Han Guo sweetener, fruit or juice, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A,pterocaryoside A, pterocaryoside B, mukurozioside, phlomisoside I, periandrin I, abrusosideA, and cyclocarioside.

In some embodiments, most (or substantially all) of the only dietary fiber in the baked goods is insoluble dietary fiber. As such, the baked goods include from about 7 wt. % to about 41 wt. % total dietary fiber in some embodiments. Notably, in some implementations, the baked goods contain soluble dietary fiber, which, as mentioned above, cannot be digested by human enzymes. Such soluble dietary fiber may be intrinsic to the bulking agent, or added.

In some embodiments, the baked goods may include from about 5 wt. % to about 12 wt. % soluble dietary fiber and from about 12 wt. % to about 53 wt. % total dietary fiber, and in certain implementations, the ratio of total dietary fiber to fat is from about 1.0 to about 5.5.

Commercially available bulking agents rich in soluble fibers that may be used in the baked goods according to some embodiments described herein include, but are not limited to: polydextrose, inulin, fructo-oligosaccharides, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, human milk oligosaccharides, 2′-fucosyl lactose, lacto-n-neotetraose, glucan (i.e., glucose containing) oligosaccharides, isomalto-oligosaccharides, cello-oligosaccharides (or cellodextrins), resistant dextrins (e.g., soluble corn fiber, soluble wheat fiber, soluble tapioca fiber), nigero-oligosaccharides, nigerotriose, nigerotetraose, kojitriose, kojitetraose, dextrans, beta glucans, lichenan, and isolichenan, and the like.

In various embodiments, the baked goods may include additional ingredients, if desired. For example, coloring ingredients, emulsifiers and flavorants, such as natural and artificial colors, sucrose monoesters, sorbitan esters, polyethoxylated glycols, agar, albumin, casein, glyceryl monostearate, gums, soaps, Irish moss, leavening agents like sodium bicarbonate, phosphates, etc., enzymes for dough processing and leavening, polyglycerol polyricinoleate (PGPR), egg yolk, lecithin, and mixtures thereof, non-fat dairy powders, cocoa, protein powders, dried fruit powders, nutrients such as vitamins, minerals, bioactives such as adaptogens, dietary supplements, inclusions such as chocolate chips, coated chocolate chips, coffee beans, pieces of fruit, vegetables, seeds or nuts, visible toppings of whole grain pieces (e.g., oatmeal), pieces of confectionery (e.g., sprinkles), etc.

Advantages and embodiments of the baked goods described herein are further illustrated by the following examples; however, the particular conditions, processing schemes, materials, and amounts thereof recited in these examples should not be construed to unduly limit the overall scope of the contemplated compositions.

All percentages recited herein are by weight unless specified otherwise.

### EXAMPLES

The following examples provide some exemplary comparative and inventive baked goods. As mentioned above, it was surprisingly and unexpectedly discovered by the inventors that low calorie and low fat baked goods such as biscuits, cookies, etc. can be successfully prepared while replacing the fat and sugar content with insoluble dietary fibers and low calorie bulking agents while maintaining the moisture level of the baked goods below 15% and the total product calories in the 180-320 kcal per 100g range.

### Example 1 (Inventive)

A target biscuit composition was developed and is shown in Table 1 below. Since the fiber content of typical soft wheat flour is generally low, certain high fiber ingredients were incorporated into the biscuit formulation. These included high amylose wheat flour (an inherently high fiber refined wheat flour from soft wheat, where the high fiber comes from resistant starch because of the high amylose content) and low fat cocoa powder, which are both sources of insoluble dietary fiber (IDF) and soluble corn fiber (a resistant dextrin). The IDF content of high amylose wheat flour was assumed to be 75% of the TDF, which is a reasonable assumption considering that the dietary fiber in high amylose wheat is due to the presence of resistant starch (RS2 type). To further reduce the calorie content of the baked product, allulose, a non-digestible monosaccharide (substantially zero calorie) was included at high usage level. The nutritional profile of each ingredient was considered and its contribution to the nutritional value of the baked product was calculated based on usage level (wt. % used in the product). A target moisture bakeoff of 12.94 wt. % was assumed to enable calculations.

TABLE 1
Target biscuit composition for Example1, containing ingredient nutritional profile and product nutrition

| | % used | Ingredient nutritional profile g/100 g | | | | | | Product nutrition g/100 g | | | | | |
|---|---|---|---|---|---|---|---|---|---|---|---|---|---|
| | in | kcal/ | sat | | | | | | sat | | | | |
| Ingredient | product | g | fat | fat | sugars | TDF | IDF | kcal | fat | fat | sugars | TDF | IDF |
| Sugar | 5.3 | 4.0 | — | — | 99.49 | — | — | 21.2 | — | — | 5.3 | — | — |
| Canola Oil, | 5.5 | 9.0 | 7.11 | 99.96 | — | — | — | 49.5 | 0.4 | 5.5 | — | — | — |
| High oleic | | | | | | | | | | | | | |
| Allulose, | 22.0 | — | — | — | — | — | — | — | — | — | — | — | — |
| powder | | | | | | | | | | | | | |
| (Dolcia | | | | | | | | | | | | | |
| Prima - Tate | | | | | | | | | | | | | |
| & Lyle) | | | | | | | | | | | | | |
| water | 8.6 | — | — | — | — | — | — | — | — | — | — | — | — |
| moisture | (12.94) | — | — | — | — | — | — | | | | | — | — |
| bakeoff | | | | | | | | | | | | | |
| Soft Wheat | 26.4 | 3.4 | 0.30 | 1.34 | 0.49 | 2.70 | — | 89.8 | 0.1 | 0.4 | 0.1 | 0.7 | — |
| Flour, | | | | | | | | | | | | | |
| refined | | | | | | | | | | | | | |
| High | 26.0 | 2.9 | 0.42 | 1.93 | 0.31 | 32.00 | 24.00 | 75.4 | 0.1 | 0.5 | 0.1 | 8.3 | — |
| Amylose | | | | | | | | | | | | | |
| wheat flour, | | | | | | | | | | | | | |
| refined | | | | | | | | | | | | | |
| (Healthsense - | | | | | | | | | | | | | |
| Bay State | | | | | | | | | | | | | |
| Milling) | | | | | | | | | | | | | |
| Low fat | 8.0 | 1.3 | 0.60 | 1.00 | 0.60 | 37.00 | 28.80 | 10.4 | 0.0 | 0.1 | 0.0 | 3.0 | 2.3 |
| cocoa | | | | | | | | | | | | | |
| powder | | | | | | | | | | | | | |
| (Bensdorp - | | | | | | | | | | | | | |
| Barry | | | | | | | | | | | | | |
| Callebaut) | | | | | | | | | | | | | |
| dough salt - | 0.26 | — | — | — | — | — | — | — | — | — | — | — | — |
| sodium | | | | | | | | | | | | | |
| chloride | | | | | | | | | | | | | |
| baking soda - | 0.60 | — | — | — | — | — | — | — | — | — | — | — | — |
| sodium | | | | | | | | | | | | | |
| bicarbonate | | | | | | | | | | | | | |
| soy lecithin | 0.38 | 7.24 | 15.01 | 78.00 | 3.00 | — | — | 2.7 | 0.1 | 0.1 | 0.0 | — | — |
| Soluble | 9.9 | 2.2 | — | — | 1.90 | 85.50 | — | 21.8 | — | — | 0.2 | 8.5 | — |
| Corn Fiber | | | | | | | | | | | | | |
| (Promitor 90 - | | | | | | | | | | | | | |
| Tate & | | | | | | | | | | | | | |
| Lyle) | | | | | | | | | | | | | |
| Total | 100 | | | | | | | 270.8 | 0.68 | 6.7 | 5.7 | 20.5 | 8.5 |

The dough formulation corresponding to calculations from Table 1 was prepared according to Table 2.

TABLE 1
Dough formulation for Example 1

| | |
|---|---|
| grams | % of dough |

Group1

| | | |
|---|---|---|
| Sugar | 13.25 | 4.67 |
| Allulose, powder (Dolcia Prima - Tate | 55.00 | 19.37 |
| & Lyle) | | |
| Low fat cocoa powder (Bensdorp - Barry | 20.00 | 7.04 |
| Callebaut) | | |
| dough salt - sodium chloride | 0.65 | 0.23 |
| baking soda - sodium bicarbonate | 1.5 | 0.53 |
| Vanillin crystals | 0.01 | 0.003 |
| soy lecithin | 0.95 | 0.33 |
| Soluble Corn Fiber (Promitor 90 - | 27.3 | 9.61 |
| Tate & Lyle) | | |
| Water | 21.53 | 7.23 |

Group2

| | | |
|---|---|---|
| Canola Oil, High oleic | 13.75 | 4.84 |

Group3

| | | |
|---|---|---|
| Soft Wheat Flour, refined | 66.00 | 23.24 |
| High Amylose wheat flour, refined | 65.00 | 22.89 |
| (Healthsense - Bay State Milling) | | |
| Total | 284.94 | 100 |

To prepare the dough, soluble corn fiber was first dissolved in the formula water in a 250 mL glass beaker using a magnetic stir bar. Once fully dissolved, the soluble corn fiber solution formed a clear syrup with light yellow color.

Next, all other ingredients from Group 1 (Table 2) were deposited into the bowl of a stand mixer (Hobart) with a paddle attachment for mixing. Then, the soluble corn fiber syrup was poured into the bowl. An additional 2.5 g of water was used to rinse the sides of the glass beaker to ensure complete transfer of contents into the bowl. The contents of the bowl were mixed at a setting of ‘1’ for 3 min. Next, Group 2 ingredient canola oil, which had been preheated for 1 min in a microwave was poured into the bowl, followed by mixing at a setting of ‘1’ for 1 min.

Then, the two flours in Group 3 were deposited into the bowl, followed by mixing at a setting of ‘2’ for 2.5 min, after which the paddle surfaces were scraped (to ensure complete mixing), followed by mixing for another 2.5 min at same setting. The resultant clay-like dough with a water activity (A_{w}) of 0.576 was tightly consolidated into a mass and tightly wrapped in a piece of plastic wrap (Saran wrap) and stored in ambient for 30 min (lay time). After the lay time, the water activity (A_{w}) remained nearly unchanged at 0.573. At this point, the dough was unwrapped and placed between two sheets of wax paper. It was sheeted to a final setting of “2” on an electronic dough sheeter (Rondo Burgdorf AG, Switzerland) to provide a sheeted dough. Next, the sheeted dough was cut into circles generally resembling dough pucks using a cookie cutter and transferred onto a stainless steel baking mesh. The weight of the 16 unbaked dough pucks was 80.1 g. Additionally, four of the dough pucks were placed on a smaller mesh to serve as a pilot to determine the bake time needed to achieve the target moisture loss.

The dough pucks were baked in a convection (Combi) oven, with temperature set to 340° F. (171° C.). The pucks on the pilot mesh were removed after 4 min of baking, resulting in a bake moisture loss of 9.3%, suggesting that additional bake time was needed to achieve the target of 12.94% moisture bakeoff. Hence, the mesh with 16 dough pucks was allowed to bake for 6 min, resulting in a moisture bakeoff of 12.8%, which was close to the target.

Various parameters of the baked biscuit were measured/computed, and they are listed in Tables 3A and 3B below.

TABLE 3
Parameters and Nutrition Facts of the baked biscuits of Example 1

| | |
|---|---|
| % Moisture (Computrack) | 1.8% |
| A_{w} Post Baking | 0.13 |
| Biscuit diameter (mm) | 47.50 |
| Biscuit height (stack of 4) (mm) | 19.90 |
| Nutrition Facts per 100 g | |
| Total insoluble dietary fiber content (IDF) (g) | 8.5 |
| Total dietary fiber content (TDF) (g) | 20.5 |
| Fat (g) | 6.7 |
| Sat Fat (g) | 0.7 |
| Sat fat/Fat | 10.1% |
| IDF/Fat | 1.3 |
| TDF/Fat | 3.1 |
| Sugar Replacers (low calorie bulking agents) (g) | 31.9 |
| Sugar (g) | 5.7 |
| Sugar Alcohols (g) | 0.0 |
| Energy, Calories (kcal) | 270.8 |
| Energy (kJ) | 1131.9 |
| % Calories from sugar | 8.5% |
| % Calories from fat | 22.4% |
| % Calories from sat fat | 2.3% |

### Example 2 (Inventive)

A target biscuit formulation was prepared in similar fashion to Example 1, but with several changes, for example: maltitol was used in place of allulose as the low calorie bulking agent and sugar was not used in this formulation. Soft wheat flour was not used, so high amylose wheat was the only source of wheat flour. Also, while this formulation did not contain cocoa powder, it did contain rather high levels of insoluble fiber through the addition of oat fiber, as well as resistant starches (RS4) from wheat and potato. The dough formulation was prepared according to Table 4.

TABLE 4
Dough formulation for Example 2

| | |
|---|---|
| grams | % of dough |

Group1

| | | |
|---|---|---|
| Canola Oil, High oleic | 25.00 | 8.64 |
| Oat fiber (BCS30 SX2 - Grain Millers) | 22.50 | 7.78 |

Group2

| | | |
|---|---|---|
| Soluble Corn Fiber (Promitor 90 - Tate & Lyle) | 16.48 | 5.70 |
| Maltitol | 25 | 8.64 |
| Water | 35.00 | 12.10 |

Group3

| | | |
|---|---|---|
| High Amylose wheat flour, refined (Healthsense - | 70.00 | 24.20 |
| Bay State Milling) | | |
| Modified potato starch (RS4) (Versafibe1490 - | 42.50 | 14.69 |
| Ingredion) | | |
| Modified wheat starch (RS4) (FiberriteRW - | 50.00 | 17.29 |
| MGP Ingredients) | | |
| Baking soda - sodium bicarbonate | 1.50 | 0.52 |
| Ammonium bicarbonate | 0.33 | 0.11 |
| Soy lecithin | 0.95 | 0.33 |
| Total | 281.75 | 100 |

To prepare the dough, similar to Example 1, the soluble corn fiber was first dissolved in water and the canola oil was pre-heated in microwave. Next, all other ingredients from Group 1 above were charged into the bowl of a stand mixer (KitchenAid) with flex-edge paddle attachment for mixing. Mixing was allowed for 3 min at a speed setting of 2′ on the KitchenAid. This ensured the coating of the insoluble oat fiber in oil. Then, the ingredients of Group 2, i.e., the soluble corn fiber (already pre-dissolved in the formula water) and maltitol were added, followed by mixing for 1 min at ‘2’. This resulted in a soft batter with a ‘creamy’ consistency. Finally, the ingredients of group 3 were deposited into the KitchenAid bowl and mixing was carried out at ‘4’ for 5 min. The resultant dough was very dry, with a powdery texture, but with surprisingly high water activity (A_{w}) of 0.81. It was then consolidated into a mass and tightly wrapped in plastic wrap and stored in ambient for 30 min (lay time). The lay time did not significantly impact the water activity.

The dough mass achieved a crumbly texture that could be consolidated into a cohesive material under manually applied pressure. The dough was then placed on a silicone baking mat and covered with the plastic wrap. A rolling pin with ⅛ inch spacer bands was used to flatten the dough into a sheet. Next, the sheeted dough was cut into circles (i.e., dough pucks) using a cookie cutter as in Example 1 and transferred onto a stainless steel baking mesh. The dough pucks were baked in a convection (Combi) oven, with temperature set to 325° F. (162.7° C.). After 5 min of baking, a moisture loss of 16.7% was achieved, which was the target moisture loss. The final product was a light colored (very low browning), firm textured biscuit, with a water activity (A_{w}) of 0.20 and 3.3% moisture. Various parameters of the baked biscuit were measured/computed, and they are listed in Table 5 below.

TABLE 5
Parameters and Nutrition Facts of the baked biscuits of Example 2

| | |
|---|---|
| % Moisture (Computrack) | 3.3% |
| A_{w} Post Baking | 0.20 |
| Biscuit diameter (mm) | 44.40 |
| Biscuit height (stack of 4) (mm) | 11.90 |
| Nutrition Facts per 100 g | |
| Total insoluble dietary fiber content (IDF)/100 g | 40.5 |
| Total dietary fiber content (TDF)/100 g | 48.5 |
| Fat (g) | 11.0 |
| Sat Fat (g) | 1.0 |
| Sat fat/Fat | 8.7% |
| IDF/Fat | 3.7 |
| TDF/Fat | 4.4 |
| Sugar Replacers (low calorie bulking agents) (g) | 16.8 |
| Sugar (g) | 0.3 |
| Sugar Alcohols (g) | 10.1 |
| Energy, Calories (kcal) | 236.9 |
| Energy (kJ) | 991.3 |
| % Calories from sugar | 0.5% |
| % Calories from fat | 40.8% |
| % Calories from sat fat | 3.6% |

### Example 3 (Inventive)

A target biscuit formulation was prepared, in similar fashion as described above, but with several changes, for example: almond butter was used as the source of fat, allulose as the low calorie sweetener and high amylose wheat flour, oat fiber and modified wheat starch (RS4) as sources of insoluble dietary fiber. The dough formulation was prepared according to Table 6.

TABLE 6
Dough formulation for Example 3

| | |
|---|---|
| grams | % of dough |

Group1

| | | |
|---|---|---|
| Almond Butter (Classic creamy - Wild Friends) | 30.75 | 11.01 |
| Allulose, powder (Dolcia Prima - Tate & Lyle) | 37.50 | 13.43 |
| Water | 41.75 | 14.95 |

Group2

| | | |
|---|---|---|
| High Amylose wheat flour, refined (Healthsense - | 87.50 | 31.33 |
| Bay State Milling) | | |
| Modified wheat starch (RS4) (FibersymRW - | 45.00 | 16.11 |
| MGP Ingredients) | | |
| Oat fiber (BCS30 SX2 - Grain Millers) | 33.88 | 12.13 |
| Baking soda - sodium bicarbonate | 2.00 | 0.72 |
| Ammonium bicarbonate | 0.75 | 0.27 |
| Dough salt | 0.13 | 0.04 |
| Total | 279.25 | 100 |

To prepare the dough, the ingredients in Group 1 from the table above were first mixed for 3 min in a KitchenAid stand mixer at a setting of ‘2’, which created a slurry. The slurry was further mixed at the slower speed setting of ‘stir’ for 1 min. Next, the dry ingredients in Group 2 were added into the bowl, followed by mixing at ‘2’ for 2 min. The resultant dough was quite powdery, with a water activity (A_{w}) of 0.82. It was then consolidated into a mass and tightly wrapped in plastic wrap and stored in ambient for 30 min (lay time), similar to Example 2.

There was no change to water activity after the lay time of 30 min, and the powdery dough was placed on silicone baking mat and covered with a plastic wrap. A rolling pin with ⅛ inch spacer bands was used to flatten the dough into a sheet. A significant amount of pressure and rolling was required to prevent the powdery dough from falling apart. Also, a great deal of care had to be taken while cutting the dough into circles (dough pucks) using the cookie cutter and transferring onto the stainless steel baking mesh.

Just 2 min of baking in a convection (Combi) oven at 325° F. (162.7)° C. resulted in the target moisture loss of 13.3% and resulted in a light colored, cookie that had a crisp, airy, wafer-like texture. The very high IDF/fat ratio of 4.5 made it extremely challenging to successfully make biscuits from this formulation. The IDF/fat ratio of 4.5 used in Example 3 may be considered to be at the critical upper limit at which a biscuit can still be created using a standard rolling and scoring process. Various parameters of the baked biscuit were measured/computed, and they are listed in Table 7 below.

TABLE 7
Parameters and Nutrition Facts of the baked biscuits of Example 3

| | |
|---|---|
| % Moisture (Computrack) | 4.1% |
| A_{w} Post Baking | 0.30 |
| Biscuit diameter (mm) | 44.60 |
| Biscuit height (stack of 4) (mm) | 13.80 |
| Nutrition Facts per 100 g | |
| Total insoluble dietary fiber content (IDF)/100 g | 34.7 |
| Total dietary fiber content (TDF)/100 g | 39.0 |
| Fat (g) | 7.7 |
| Sat Fat (g) | 0.8 |
| Sat fat/Fat | 10.9% |
| IDF/Fat | 4.5 |
| TDF/Fat | 5.1 |
| Sugar Replacers (low calorie bulking agents) (g) | 15.2 |
| Sugar (g) | 1.0 |
| Sugar Alcohols (g) | 0.0 |
| Energy, Calories (kcal) | 187.6 |
| Energy (kJ) | 785.1 |
| % Calories from sugar | 2.1% |
| % Calories from fat | 36.2% |
| % Calories from sat fat | 3.9% |

### Example 4 (Comparative)

A target biscuit formulation was prepared, in similar fashion to Example 3, but with only a slight reduction in the almond butter and corresponding slight increase in oat fiber content, with no other changes. This was done to increment the IDF/fat ratio above the critical upper IDF/fat threshold to 4.6. The dough formulation was prepared according to Table 6.

TABLE 8
Dough formulation for Example 4

| | |
|---|---|
| grams | % of dough |

Group1

| | | |
|---|---|---|
| Almond Butter (Classic creamy - Wild Friends) | 30.38 | 10.88 |
| Allulose, powder (Dolcia Prima - Tate & Lyle) | 37.50 | 13.43 |
| Water | 41.75 | 14.95 |

Group2

| | | |
|---|---|---|
| High Amylose wheat flour, refined (Healthsense - | 87.50 | 31.33 |
| Bay State Milling) | | |
| Modified wheat starch (RS4) (FibersymRW - | 45.00 | 16.11 |
| MGP Ingredients) | | |
| Oat fiber (BCS30 SX2 - Grain Millers) | 34.25 | 12.26 |
| Baking soda - sodium bicarbonate | 2.00 | 0.72 |
| Ammonium bicarbonate | 0.75 | 0.27 |
| Dough salt | 0.13 | 0.04 |
| Total | 279.25 | 100 |

The mixing of ingredients in Group 1 was identical to that of Example 3. Also, just like Example 3, the dry ingredients of Group 2 were added into the bowl and mixed for 2 min.

However, the mass after mixing did not hold together at all, resulting in a powder that could not be used to create a dough.

Wrapping the powder tightly in a plastic wrap also failed to provide a cohesive mass that could be rolled and scored to obtain dough pucks.

Rather, the mass fell apart as a powder.

Notably, the IDF/fat ratio in Comparative Example 4 was 4.6 and did not result in a successful biscuit, while in Inventive Example 3, the IDF/fat ratio was 4.5, and resulted in a successful biscuit.

Therefore, it appears that an IDF/fat ratio of 4.5 is a critical upper limit for achieving a dough suitable for baking biscuits when using conventional rolling and scoring process to make the biscuits.

Some notable exceptions may be related to the use of non-traditional processes such as extrusion and/or compression molding, where excessive pressure may be applied to sinter powders into a cohesive mass.

However, such techniques are not conventionally employed in biscuit manufacturing.

Various parameters of the baked product resulting from the formulation of Table 8 were measured/computed, and they are listed in Table 9 below.

TABLE 9
Parameters and Nutrition Facts of the baked product of Example 4

| % Moisture (Computrack) | n/a |
|---|---|
| A_{w} Post Baking | n/a |
| Biscuit diameter (mm) | n/a |
| Biscuit height (stack of 4) (mm) | n/a |
| Nutrition Facts per 100 g | |
| Total insoluble dietary fiber content (IDF)/100 g | 34.9 |
| Total dietary fiber content (TDF)/100 g | 39.1 |
| Fat (g) | 7.6 |
| Sat Fat (g) | 0.8 |
| Sat fat/Fat | 10.9% |
| IDF/Fat | 4.6 |
| TDF/Fat | 5.1 |
| Sugar Replacers (low calorie bulking agents) (g) | 15.2 |
| Sugar (g) | 1.0 |
| Sugar Alcohols (g) | 0.0 |
| Energy, Calories (kcal) | 186.8 |
| Energy (kJ) | 781.5 |
| % Calories from sugar | 2.1% |
| % Calories from fat | 35.9% |
| % Calories from sat fat | 3.9% |

### Example 5 (Comparative)

The formulation was prepared to recreate Comparative Example 3, but with a very high IDF/fat ratio of 5.8.

As can be expected from the result of Comparative Example 4, the formulation of Comparative Example 5 failed to result in a cohesive dough and therefore did not end up creating a successful biscuit.

This once again proved that a dough formulation with an IDF/fat ratio of above 4.5 does not result in an acceptable biscuit.

The dough formulation was prepared according to Table 10.

TABLE 10
Dough formulation for Example 5

| | |
|---|---|
| grams | % of dough |

Group1

| | | |
|---|---|---|
| Almond Butter (Classic creamy - Wild Friends) | 25.00 | 8.87 |
| Allulose, powder (Dolcia Prima - Tate & Lyle) | 37.50 | 13.31 |
| Water | 31.75 | 11.27 |
| Short Chain Fructo Oligosaccharides (Nutraflora | 9.63 | 3.42 |
| P95 scFOS - Ingredion) | | |

Group2

| | | |
|---|---|---|
| High Amylose wheat flour, refined (Healthsense - | 87.50 | 31.06 |
| Bay State Milling) | | |
| Modified wheat starch (RS4) (FibersymRW - | 37.50 | 13.31 |
| MGP Ingredients) | | |
| Oat fiber (BCS30 SX2 - Grain Millers) | 50.00 | 17.75 |
| Baking soda - sodium bicarbonate | 2.00 | 0.71 |
| Ammonium bicarbonate | 0.75 | 0.27 |
| Dough salt | 0.13 | 0.04 |
| Total | 281.75 | 100 |

Various parameters of the baked product resulting in from the formulation in Table 10 were measured/computed, and they are listed in Table 11 below.

TABLE 11
Parameters and Nutrition Facts of the baked product of Example 5

| % Moisture (Computrack) | n/a |
|---|---|
| A_{w} Post Baking | n/a |
| Biscuit diameter (mm) | n/a |
| Biscuit height (stack of 4) (mm) | n/a |
| Nutrition Facts per 100 g | |
| Total insoluble dietary fiber content (IDF)/100 g | 37.3 |
| Total dietary fiber content (TDF)/100 g | 44.8 |
| Fat (g) | 6.4 |
| Sat Fat (g) | 0.7 |
| Sat fat/Fat | 11.6% |
| IDF/Fat | 5.8 |
| TDF/Fat | 7.0 |
| Sugar Replacers (low calorie bulking agents) (g) | 18.9 |
| Sugar (g) | 1.0 |
| Sugar Alcohols (g) | 0.0 |
| Energy, Calories (kcal) | 179.4 |
| Energy (kJ) | 750.6 |
| % Calories from sugar | 2.3% |
| % Calories from fat | 31.3% |
| % Calories from sat fat | 3.6% |

### Example 6 (Inventive)

A target biscuit formulation was prepared, in the style of a modified (Cereals & Grains Association) AACC 10.53 recipe format. This formulation is significantly different from the other examples used herein. The main differentiating factors include: a blend of anhydrous milk fat and canola oil to increase the saturated fat content of the product, and nonfat dry milk powder. This formulation showed that the inventive concept described herein is applicable to butter or tea biscuit formulations with a higher saturated fat content than the biscuits using canola oil in entirety. The main sources of fiber for this non-chocolate biscuit is the modified wheat starch (RS4). The dough formulation was prepared according to Table 12.

TABLE 12
Dough formulation for Example 6

| | |
|---|---|
| grams | % of dough |

Group1

| | | |
|---|---|---|
| Milkfat (Dairy Farmers of America) | 16.25 | 5.84 |
| Canola Oil, High Oleic | 18.75 | 6.74 |
| Non-fat Dry Milk (Dairy Farmers of America) | 17.50 | 6.29 |

Group2

| | | |
|---|---|---|
| Soluble Corn Fiber (Promitor 90 - Tate & Lyle) | 4.88 | 1.75 |
| Maltitol | 62.50 | 22.46 |
| Water | 29.25 | 10.51 |
| Dough salt | 0.13 | 0.04 |

Group3

| | | |
|---|---|---|
| High Amylose wheat flour, refined (Healthsense - | 76.25 | 27.40 |
| Bay State Milling) | | |
| Modified wheat starch (RS4) (FibersymRW - | 50.00 | 17.97 |
| MGP Ingredients) | | |
| Baking soda - sodium bicarbonate | 2.00 | 0.72 |
| Ammonium bicarbonate | 0.75 | 0.27 |
| Total | 278.25 | 100 |

To prepare the dough, Group 1 was mixed to create an aerated cream. Group 2 was then added and mixed for one minute on setting 4. Appearance of the mixture at this stage looked very similar to after the first mixing stage. Group 3 was then added and was incorporated in a two-speed mixing process. First at speed ‘2’ for 1 minute to incorporate and then at speed ‘4’ for 3 minutes. The resultant dough was similar to a typical sugar cookie dough, with a water activity (A_{w}) of 0.70. Unlike the other inventive examples described herein, the AACC 10.53 format which was followed in this example does not use a lay time. Therefore, the dough mixing step was immediately followed by forming and baking. The water activity after mixing was 0.70.

The dough forming step was also different from other examples. The dough was portioned into six equal pieces and spread out evenly on a solid aluminum baking tray with a lip. Using a stainless-steel rolling pin with a pin-sock on it the dough was rolled out to the thickness of the tray lip. The dough was then cut into circles (i.e., dough pucks) with a round cutter and the excess dough was removed from the tray. The removed dough was then reincorporated to make more biscuits. The dough pucks were baked in a convection (Combi) oven at 325° F. (162.7° C.) for 7 min and reached a 11.82% moisture loss during the process. The resulting biscuits had golden brown edges, and a flat continuous surface. They had crispy texture, with a distinct ‘buttery’ note, coming from the dairy ingredients. The A_{w} was 0.31, and the moisture content 3.09%.

Various parameters of the baked biscuit were measured/computed, and they are listed in Table 13 below.

TABLE 13
Parameters and Nutrition Facts of the baked biscuits of Example 6

| | |
|---|---|
| % Moisture (Computrack) | 3.1% |
| A_{w} Post Baking | 0.33 |
| Biscuit diameter (mm) | 72.60 |
| Biscuit height (stack of 4) (mm) | 31.60 |
| Nutrition Facts per 100 g | |
| Total insoluble dietary fiber content (IDF)/100 g | 23.3 |
| Total dietary fiber content (TDF)/100 g | 27.7 |
| Fat (g) | 15.1 |
| Sat Fat (g) | 4.8 |
| Sat fat/Fat | 31.8% |
| IDF/Fat | 1.5 |
| TDF/Fat | 1.8 |
| Sugar Replacers (low calorie bulking agents) (g) | 27.1 |
| Sugar (g) | 3.8 |
| Sugar Alcohols (g) | 25.1 |
| Energy, Calories (kcal) | 304.8 |
| Energy (kJ) | 1275.1 |
| % Calories from sugar | 5.0% |
| % Calories from fat | 43.5% |
| % Calories from sat fat | 13.8% |

### Example 7 (Inventive)

A target biscuit formulation was prepared without any allulose or maltitol as low calorie bulking agent. Instead, two soluble dietary fibers, short chain fructo-oligosaccharides (scFOS) and soluble corn fiber were used as the low calorie bulking agent. Similar to Example 3, the high amylose wheat flour was used as the only flour source and modified wheat starch (RS4) was used as a source of IDF. But unlike Example 3, instead of using oat fiber as an additional source of IDF, low fat cocoa powder was used. The dough formulation was prepared according to Table 14.

TABLE 14
Dough formulation for Example 7

| | |
|---|---|
| Grams | % of dough |

Group1

| | | |
|---|---|---|
| Short Chain Fructo-Oligosaccharides (Nutraflora | 45.00 | 15.83 |
| P95 scFOS - Ingredion) | | |
| Low fat cocoa powder (Bensdorp - Barry | 22.5 | 7.92 |
| Callebaut) | | |
| Soluble Corn Fiber (Promitor 90 - Tate & Lyle) | 3.48 | 1.22 |
| Water | 23.00 | 8.09 |

Group2

| | | |
|---|---|---|
| Canola Oil, High oleic | 20.00 | 7.04 |

Group3

| | | |
|---|---|---|
| Modified wheat starch (RS4) (FibersymRW - | 50.00 | 17.59 |
| MGP Ingredients) | | |
| High Amylose wheat flour, refined (Healthsense - | 117.50 | 41.34 |
| Bay State Milling) | | |
| Baking soda - sodium bicarbonate | 1.50 | 0.53 |
| Ammonium bicarbonate | 0.33 | 0.11 |
| Soy lecithin | 0.95 | 0.33 |
| Total | 284.25 | 100 |

To prepare the dough according to the formulation in Table 14, soluble corn fiber was first pre-dissolved in the formula water in a KitchenAid stand mixer bowl, followed by the addition of remaining ingredients of group 1, which were then mixed at a setting of ‘2’ for 3 min.

Next, the oil (group 2) was added, followed by mixing for another minute on the same setting, resulting in the formation of a dark brown slurry.

Then, the dry ingredients of group 3 were deposited into the bowl and mixed at a setting of ‘4’ for 5 min, which produced a light brown dough that was sufficiently cohesive.

The dough, with a water activity (A_{w}) of 0.71, was then wrapped tightly in plastic wrap and stored for 30 min lay time.

The lay time did not notably affect water activity.

The dough was then rolled, formed and scored into circles (i.e., dough pucks) following same procedure as Example 3, and baked in a convection (Combi) oven at 325° F. (162.7° C.) for 4 min and 15 seconds, resulting in the target moisture loss of 13.5% and a water activity (A_{w}) of 0.20.

The baked products had a distinct brown color and airy texture, while being less sweet than in Example 1 because no sugar, sugar alcohol or other ‘sweetener’ was added to the formulation of Example 7.

The sweetness in Example 7 came from short chain FOS, which is known to have a mildly sweet taste.

Various parameters of the baked biscuit were measured/computed, and they are listed in Table 15 below.

TABLE 15
Parameters and Nutrition Facts of the baked biscuits of Example 7

| | |
|---|---|
| % Moisture (Computrack) | 3.9% |
| A_{w} Post Baking | 0.24 |
| Biscuit diameter (mm) | 44.90 |
| Biscuit height (stack of 4) (mm) | 14.70 |
| Nutrition Facts per 100 g | |
| Total insoluble dietary fiber content (IDF)/100 g | 29.7 |
| Total dietary fiber content (TDF)/100 g | 52.2 |
| Fat (g) | 9.4 |
| Sat Fat (g) | 0.9 |
| Sat fat/Fat | 9.7% |
| IDF/Fat | 3.2 |
| TDF/Fat | 5.5 |
| Sugar Replacers (low calorie bulking agents) (g) | 19.4 |
| Sugar (g) | 1.0 |
| Sugar Alcohols (g) | 0.0 |
| Energy, Calories (kcal) | 269.3 |
| Energy (kJ) | 1126.6 |
| % Calories from sugar | 1.5% |
| % Calories from fat | 31.5% |
| % Calories from sat fat | 3.1% |

### Example 8 (Inventive)

A target biscuit formulation was prepared in a fashion that is similar but not identical to example 1, but using erythritol as the sweetener. Other minor differences from Example 1 include differences in usage levels of ingredients in common and the use of ammonium bicarbonate as a leavening agent. The dough formulation was prepared according to Table 16.

TABLE 16
Dough formulation for Example 8

| | |
|---|---|
| Grams | % of dough |

Group1

| | | |
|---|---|---|
| Sugar | 13.25 | 4.79 |
| dough salt | 0.65 | 0.23 |
| Low fat cocoa powder (Bensdorp - Barry | 25.00 | 9.03 |
| Callebaut) | | |
| Water | 28.03 | 10.13 |
| Erythritol (Zerose - Cargill) | 55.88 | 20.19 |

Group2

| | | |
|---|---|---|
| Canola Oil, High oleic | 20.00 | 7.23 |

Group3

| | | |
|---|---|---|
| Soft Wheat Flour, refined | 65.00 | 23.49 |
| High Amylose wheat flour, refined (Healthsense - | 65.00 | 23.49 |
| Bay State Milling) | | |
| Baking soda - sodium bicarbonate | 1.50 | 0.54 |
| Ammonium bicarbonate | 1.50 | 0.54 |
| Soy lecithin | 0.95 | 0.34 |
| Total | 276.75 | 100 |

To prepare the dough according to the formulation in Table 16, the ingredients in Group 1 were charged into KitchenAid stand mixer bowl and mixed for 3 min at a setting of ‘2’. Meanwhile, canola oil (group 2) was preheated for 1 min in a microwave.

Next, the preheated canola oil was added into the bowl and mixed at ‘2’, forming a dark brown slurry. The ingredients of group 3 were then added into the bowl and mixed for another 5 min at a mixer speed of ‘4’, which gave a clumpy dough.

The dough was then tightly wrapped in a plastic wrap and allowed a 30 min lay time.

The water activity (A_{w}) of the dough changed from 0.83 right after mixing to 0.87 after lay time.

The dough was then rolled, formed and scored into circles (i.e., dough pucks) following same procedure as Example 3, and then baked in a convection (Combi) oven at 325° F. (162.7° C.) for 8 min, resulting in a moisture loss of 15.11%, which was close to the target moisture loss of 15.3%.

The dark colored biscuits, with a water activity (A_{w}) of 0.46 were rather puffy in appearance and had softer texture.

Various parameters of the baked biscuit were measured/computed, and they are listed in Table 17 below.

TABLE 17
Parameters and Nutrition Facts of the baked biscuits of Example 8

| | |
|---|---|
| % Moisture (Computrack) | 4.4% |
| A_{w} Post Baking | 0.33 |
| Biscuit diameter (mm) | 44.40 |
| Biscuit height (stack of 4) (mm) | 24.50 |
| Nutrition Facts per 100 g | |
| Total insoluble dietary fiber content (IDF)/100 g | 9.5 |
| Total dietary fiber content (TDF)/100 g | 13.3 |
| Fat (g) | 9.6 |
| Sat Fat (g) | 0.9 |
| Sat fat/Fat | 9.5% |
| IDF/Fat | 1.0 |
| TDF/Fat | 1.4 |
| Sugar Replacers (low calorie bulking agents) (g) | 23.3 |
| Sugar (g) | 5.8 |
| Sugar Alcohols (g) | 23.3 |
| Energy, Calories (kcal) | 284.1 |
| Energy (kJ) | 1188.6 |
| % Calories from sugar | 8.1% |
| % Calories from fat | 20.4% |
| % Calories from sat fat | 2.9% |

### Example 9 (Comparative)

A target biscuit formulation was designed to explore the impact of very high moisture content in the dough making process.

Generally, it is reasonable to expect that a high water content in the dough may allow it to become more cohesive and hence provide a biscuit, even at a high IDF content. The dough formulation was prepared according to Table 18.

TABLE 18
Dough formulation for Example 9

| | |
|---|---|
| grams | % of dough |

Group1

| | | |
|---|---|---|
| Sugar | 49.50 | 17.44 |
| Sunflower Butter (natural - SunButter) | 10.00 | 3.52 |
| Short Chain Fructo Oligosaccharides (Nutraflora | 25.00 | 8.81 |
| P95 scFOS - Ingredion) | | |
| Modified wheat starch (RS4) (FiberriteRW - | 26.78 | 9.44 |
| MGP Ingredients) | | |
| Soy lecithin | 0.95 | 0.33 |

Group2

| | | |
|---|---|---|
| Soft Wheat Flour, refined | 50.00 | 17.62 |
| High Amylose wheat flour, refined (Healthsense - | 16.45 | 5.80 |
| Bay State Milling) | | |
| Low fat cocoa powder (Bensdorp - Barry | 35.00 | 12.33 |
| Callebaut) | | |
| Baking soda - sodium bicarbonate | 1.50 | 0.53 |
| Ammonium bicarbonate | 0.50 | 0.18 |
| Dough salt | 0.58 | 0.20 |

Group3

| | | |
|---|---|---|
| Water | 67.50 | 23.79 |
| Total | 283.75 | 100 |

To prepare the dough according to the formulation in Table 18, the ingredients in Group 1 were first mixed for 4 min in a KitchenAid stand mixer with a flex edge paddle at a speed setting of ‘4’.

Next, the dry ingredients in Group 2 were added and mixed for 2 min at a speed setting of ‘stir’.

Then, the water (Group 3) was added and mixing was allowed for 3 min at a setting of ‘4’, resulting in a dough with a water activity (A_{w}) of 0.88.

The dough was tightly wrapped in plastic wrap and allowed a lay time of 30 min, which did not impact water activity.

The dough was then rolled, formed and scored into circles (i.e., dough pucks) following same procedure as Example 3.

Baking for 6 min in a convection (Combi) oven at 325° F. (162.7° C.) resulted in the target moisture loss of 14%. However, the product still had high water activity (A_{w}) of 0.75 and extremely high product moisture content of 15.3%, which is undesirable due to risks of microbial growth in the product over shelf life.

Notably, Comparative Example 9 demonstrates the challenge of using additional formula water to overcome challenges presented by a ‘dry’ dough due to high IDF content.

Various parameters of the product baked based upon the formulation in Table 18 were measured/computed, and they are listed in Table 19 below.

TABLE 19
Parameters and Nutrition Facts of the baked product of Example 9

| | |
|---|---|
| % Moisture (Computrack) | 15.3% |
| A_{w} Post Baking | 0.75 |
| Biscuit diameter (mm) | 45.10 |
| Biscuit height (stack of 4) (mm) | 21.30 |
| Nutrition Facts per 100 g | |
| Total insoluble dietary fiber content (IDF)/100 g | 14.2 |
| Total dietary fiber content (TDF)/100 g | 27.1 |
| Fat (g) | 10.9 |
| Sat Fat (g) | 1.2 |
| Sat fat/Fat | 10.9% |
| IDF/Fat | 1.3 |
| TDF/Fat | 2.5 |
| Sugar Replacers (low calorie bulking agents) (g) | 10.0 |
| Sugar (g) | 6.5 |
| Sugar Alcohols (g) | 0.0 |
| Energy, Calories (kcal) | 273.4 |
| Energy (kJ) | 1143.7 |
| % Calories from sugar | 9.5% |
| % Calories from fat | 35.8% |
| % Calories from sat fat | 3.9% |

### Example 10 (Inventive)

A target biscuit formulation was prepared with to target a low IDF/fat ratio of 0.6. Sunflower butter was used as the source of fat.

Compared to the other examples, it did not contain any known sources of resistant starch, i.e., no RS4 or High Amylose wheat flour.

Therefore, the added oat fiber and soft wheat flour were the only sources of insoluble dietary fiber.

The dough formulation was prepared according to Table 20.

TABLE 20
Dough formulation for Example 10

| | |
|---|---|
| grams | % of dough |

Group1

| | | |
|---|---|---|
| Allulose, powder (Dolcia Prima - Tate & Lyle) | 55.00 | 19.70 |
| Water | 23.00 | 8.24 |
| Soluble Corn Fiber (Promitor 90 - Tate & Lyle) | 10.33 | 3.70 |

Group2

| | | |
|---|---|---|
| Sunflower Butter (natural - SunButter) | 65.00 | 23.28 |

Group3

| | | |
|---|---|---|
| Soft Wheat Flour, refined | 100.00 | 35.81 |
| Oat fiber (BCS30 SX2 - Grain Millers) | 22.50 | 8.06 |
| Dough salt | 0.65 | 0.23 |
| Baking soda - sodium bicarbonate | 1.83 | 0.65 |
| Soy lecithin | 0.95 | 0.34 |
| Total | 279.25 | 100 |

To prepare the dough according to the formulation in Table 20, the ingredients in Group 1 were first mixed for 3 min in a KitchenAid stand mixer with a flex edge paddle at a speed setting of ‘2’.

Next, the sunflower butter in Group 2 was added and mixed for 1 min at a speed setting of ‘2’. Then, the ingredients in Group 3 were added and mixing was continued for 7 min at a setting of ‘4’, which produced a cohesive dough with water activity (A_{w}) of 0.65.

This value was unchanged after the dough was tightly wrapped in plastic wrap and allowed a lay time of 30 min.

The dough was then placed rolled on silicone baking mat and covered with a plastic wrap. A rolling pin with ⅛ inch spacer bands was used to roll the dough, which easily formed into a flat sheet. It was then scored into circles (dough pucks) and transferred onto a stainless steel mesh for baking.

Baking for 8 min in a convection (Combi) oven at 325° F. (162.7° C.) resulted in the target moisture loss of 11.8%. The brown colored cookies, with water activity (A_{w}) of 0.29, were described to have a ‘toasting, nutty’ flavor and a ‘slightly hard initial bite that crumbled nicely in mouth’.

Various parameters of the baked biscuit were measured/computed, and they are listed in Table 21 below.

TABLE 21
Parameters and Nutrition Facts of the baked biscuits of Example 10

| | |
|---|---|
| % Moisture (Computrack) | 1.0% |
| A_{w} Post Baking | 0.29 |
| Biscuit diameter (mm) | 47.30 |
| Biscuit height (stack of 4) (mm) | 17.03 |
| Nutrition Facts per 100 g | |
| Total insoluble dietary fiber content (IDF)/100 g | 7.7 |
| Total dietary fiber content (TDF)/100 g | 13.9 |
| Fat (g) | 13.9 |
| Sat Fat (g) | 1.4 |
| Sat fat/Fat | 10.4% |
| IDF/Fat | 0.6 |
| TDF/Fat | 1.0 |
| Sugar Replacers (low calorie bulking agents) (g) | 26.1 |
| Sugar (g) | 2.8 |
| Sugar Alcohols (g) | 0.0 |
| Energy, Calories (kcal) | 312.8 |
| Energy (kJ) | 1308.7 |
| % Calories from sugar | 3.6% |
| % Calories from fat | 39.9% |
| % Calories from sat fat | 4.1% |

The baked products described herein advantageously have reduced fat, sugar, and calorie content while having low moisture, low water activity, and high insoluble dietary fiber content, while exhibiting pleasant organoleptic properties when consumed.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A baked good comprising:
from about 7 wt. % to about 41 wt. % insoluble dietary fiber;
from about 5 wt. % fat to about 16 wt. % fat;
a ratio of the insoluble dietary fiber to the fat of from about 0.5 to about 4.5;
from about 10 wt. % to about 35 wt. % low calorie bulking agent;
sugar in an amount of up to 10 wt. %;
moisture in an amount of up to 15 wt. %;
a water activity of up to 0.7; and
a total caloric content of about 180-320 kcal per 100 g of the baked good.

2. The baked good of claim 1, wherein the baked good is a biscuit or a cookie.

3. The baked good of claim 1, wherein the insoluble dietary fiber is from a source including at least one of: brans, celluloses, hemicelluloses, lignins, resistant starches, flours, insoluble chicory root fiber, isolated plant fibers, cocoa powder, pecan shell fiber, maple fiber, cocoa pod husk fiber, and agave pina fiber.

4. The baked good of claim 1, wherein the sugar comprises a saccharide having an energy content of less than or equal to 3 kcal/g.

5. The baked good of claim 1, wherein the low calorie bulking agent comprises a saccharide having an energy content of less than or equal to 3 kcal/g.

6. The baked good of claim 1, wherein the low calorie bulking agent is a sugar alcohol.

7. The baked good of claim 1, wherein the low calorie bulking agent is not a sugar alcohol.

8. The baked good of claim 1, wherein the fat is selected from a group consisting of: canola oil, palm oil, high oleic canola oil, soybean, safflower, sunflower, palm kernel oil, shea butter, mango kernel oil, illipe oil, sal oil, olive oil, milk fat, cocoa butter or fractions or equivalents of cocoa butter, polyglycerol esters, glycerophospholipids, mono-and di-glycerides, sucrose monoesters, sorbitan esters, polyethoxylated glycols, agar, albumin, casein, glyceryl monostearate, gums, soaps, Irish moss, egg yolk, lecithin, and mixtures thereof.

9. The baked good of claim 1, further comprising soluble dietary fiber and from about 12 wt. % to about 53 wt. % total dietary fiber.

10. The baked good of claim 1, wherein a ratio of the total dietary fiber to the fat is from about 1.0 to about 5.5.

11. The baked good of claim 9, wherein the soluble dietary fiber is from a source including at least one of: polydextrose, inulin, fructo-oligosaccharides, kestose, nystose, raffinose, galacto-oligosaccharides, galactotriose, manno-oligosaaccharides, mannotriose, mannotetraose, soy bean oligosaccharides, arabinogalactans, xylo-oligosaccharides, xylotriose, xylotetraose, arabinoxylan-oligosaccharides, arabinotriose, arabinotetraose, human milk oligosaccharides, 2′-fucosyl lactose, lacto-n-neotetraose, glucan (i.e., glucose containing) oligosaccharides, isomalto-oligosaccharides, cello-oligosaccharides (or cellodextrins), resistant dextrins (e.g., soluble corn fiber, soluble wheat fiber, soluble tapioca fiber), nigero-oligosaccharides, nigerotriose, nigerotetraose, kojitriose, kojitetraose, dextrans, beta glucans, lichenan, and isolichenan.

12. The baked good of claim 1, wherein saturated fat comprises from about 8.5 wt. % to about 60 wt. % of a total fat content.

13. The baked good of claim 12, wherein saturated fat accounts for about 2.9% to about 13.8% of the total caloric content of the baked good.

14. The baked good of claim 1, wherein the sugar accounts for about 0.5% to about 8.5% of the total caloric content of the baked good.

15. The baked good of claim 1, wherein the fat accounts for about 20% to about 44% of the total caloric content of the baked good.
